(19) United States
(12) Patent Application Publication
(10) Pub. No.: US 2009/0288537 A1
(43) Pub. Date: Nov. 26, 2009

(54) SHEET CUTTING MACHINE

(75) Inventors: Hisahiro Hirayama, Shiga (JP); Minoru Ogawa, Shiga (JP); Hideaki Tabuchi, Shiga (JP)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: Horizon International Inc., Shiga (JP)

(21) Appl. No.: 12/468,940

(22) Filed: May 20, 2009

(30) Foreign Application Priority Data
May 23, 2008 (JP) 2008-135187

(51) Int. Cl. B26D 7/01; B26D 5/08; G05B 15/00; B26D 7/27

(52) U.S. Cl. 83/468.7; 83/613; 700/275; 83/522.11

(57) ABSTRACT

A machine includes a table (2) on which a sheet bundle (3) is placed, a cutting blade (4) cutting four sides of the sheet bundle, a blade receiving plate (5) arranged on the table, a positioning block (6) arranged on the table in parallel to the blade receiving plate for slide movement in directions toward and away from the blade receiving plate, an operation data storage section (15) storing data of a order of cutting of sides of the sheet bundle, data of a distance between a cutting line of the positioning block and the sheet bundle for each cutting operation accordance with the order of cutting, and data of both a direction and an angle of rotation of the sheet bundle for each cutting operation, and an indication section (16) indicating the order of cutting. The indication section displays on a display (11) the order of the cutting operation, the distance between the cutting line of the positioning block and the sheet bundle for the cutting operation, and the image indicating the direction of the sheet bundle with respect to the positioning block of the cutting operation, based on the data stored in the operation data storage section each time the cutting operation is carried out.

### BACKGROUND OF THE INVENTION

1. Field of the Invention

The present invention relates to a sheet cutting machine, and especially to a sheet cutting machine with a function of indicating a order of cutting of a sheet bundle.

2. Description of the Related Art

As one of book binding processes, there is a sheet cutting process in which four sides of a printed sheet bundle are cut to form a book block of a predetermined size (for example, corresponding to a size of a finished book). A sheet cutting machine is used in the sheet cutting process. FIG. 4 is a perspective view of a conventional sheet cutting machine. Referring to FIG. 4, the sheet cutting machine comprises a frame 1, and a table 2 attached to the frame 1. A sheet bundle 3 is placed on the table 2.

A cutting blade 4 cutting four sides of the sheet bundle 3 is arranged above the table 2 and opposite to the table 2. A blade receiving plate 5 is arranged on the table 2 and opposite to the cutting blade 4. The cutting blade 4 is supported by a blade drive mechanism (not shown) attached to the frame 1 in such a manner that the cutting blade 4 makes a reciprocal vertical movement between a standby position at which the cutting blade 4 is spaced apart upward from the sheet bundle 3, and a cutting position at which the cutting blade 4 comes into contact with the blade receiving plate 5 so as to cut the sheet bundle 3.

A positioning block 6 is arranged on the table 2 parallel to the blade receiving plate 5 for slide movement in directions toward and away from the blade receiving plate 5. A reference side of the sheet bundle 3 is abutted on the positioning block 6, whereby the sheet bundle 3 is positioned with respect to the cutting blade 4.

The positioning block 6 is moved by a positioning block drive mechanism attached to the frame 1, FIG. 5 is a perspective view schematically illustrating a structure of the positioning block drive mechanism. Referring to FIG. 5, the positioning block drive mechanism comprises a slit 7 formed on the table 2 and extending vertically to the blade receiving plate 5, and an extension portion 6a extending downward from a lower face of the positioning block 6 through the slit 7. The positioning block 6 is guided by the slit 7 for the slide movement. The extension portion 6a of the positioning block 6 has a through hole with a thread groove extending in a direction of the slide movement. The positioning block drive mechanism farther comprises a feed screw 8 attached to the frame 1 underside the table 7 and extending along the slit 7 and arranged for rotation around the axis thereof. The feed screw 8 is screwed into the through hole of the extension portion 6a. The feed screw 8 is connected to a motor 9 via a power transmission mechanism 9a composed of a pulley and an endless belt. The feed screw 8 is rotated by the motor 9 so that the positioning block 6 is guided by the slit 7 and slides in the directions toward and away from the blade receiving plate 5. The motor 6 is controlled by a control section 14.

The sheet cutting machine comprises an operation data storage section 15 storing data of the order of cutting of each side of the sheet bundle 3, and data of a distance between a cutting line of the positioning block 6 and the sheet bundle 3 for each cutting operation accordance with the order of cutting are recorded.

The control section 14 arranges the positioning block at a predetermined position for each cutting operation, based on the data of the distance between the cutting line of the positioning block 6 and the sheet bundle 3 for each cutting operation accordance with the operation data storage section 15.

On the table 2, a pair of auxiliary positioning blocks 10, which extend normal to the positioning block 6, are attached to both ends of the positioning block 6. Accordingly, the reference side of the sheet bundle 3 is abutted on the positioning block 6, and the second reference side of the sheet bundle 3 is abutted on one of the auxiliary positioning blocks 10, whereby the sheet bundle 3 is positioned with respect to the cutting blade 4.

The sheet cutting machine further comprises an indication section 16 indicating the order of cutting. The indication section 16 comprises a display 11 displays a screen pages indicating the order of cutting. FIG. 6 is a plan view illustrating a screen page of the display 11 of the indication section 16. FIG. 6 illustrates an example of cutting operation for manufacturing a finished book of A4 size. In FIG. 6, the reference numeral 11a represents a screen area indicating a distance between a cutting line of the positioning block 6 and the sheet bundle 3 of the next cutting operation, the reference numeral 11b represents a screen area indicating the order of cutting of four sides of the sheet, and the reference numeral 11c represents a screen area indicating the distance between the cutting line of the positioning block 6 and the sheet bundle 3 for each cutting operation accordance with the order of cutting. The reference numeral 11d represents a frame display indicating what number of cutting operation is performed next.

In other words, the screen page shown in FIG. 6 displays that the distance between the cutting line of the positioning block 6 and the sheet bundle 3 is set to 302.0 mm at a first cutting operation, the distance between the cutting line of the positioning block 6 and the sheet bundle 3 is set to 215.0 mm at a second cutting operation, the distance between the cutting line of the positioning block 6 and the sheet bundle 3 is set to 297.0 mm at a third cutting operation, and the distance between the cutting line of the positioning block 6 and the sheet bundle 3 is set to 210.0 mm at a fourth cutting operation. The screen page also indicates that the second cutting operation is performed next, and the distance between the cutting line of the positioning block 6 and the sheet bundle 3 is set to 215.0 mm.

According to this sheet cutting machine, the positioning block 6 is moved to the predetermined position (the position at which the distance between the cutting line of the positioning block 6 and the sheet bundle 3 is 302.0 mm) at the first cutting operation, and an upper side 3a of the sheet bundle 3 is abutted on the positioning block 6 on the table 2, and a left side 3c is abutted on one of the auxiliary positioning blocks 10, as shown in FIG. 7, whereby the sheet bundle 3 is positioned with respect to a cutting line 13 (the cutting blade 4). Thereafter, start switches 12a and 12b (see FIG. 4) of the sheet cutting machine are pressed by an operator, the first cutting operation is started, and the cutting blade 4 moves downward from the standby position to the cutting position, and then returned to the standby position. Accordingly, a lower side 3b of the sheet bundle 3 is cut.

When the first cutting operation is finished, the positioning block 6 is moved to the position for the second cutting operation (the position at which the distance to the cutting line 13 is 215.0 mm). The sheet bundle 3 is then rotated at 90 degrees in a counterclockwise direction by the operator, a right side 3d of the sheet bundle 3 is abutted on the positioning block 6, and the upper line 3a is abutted on one of the auxiliary positioning blocks 10, respectively, whereby the sheet bundle 3 is positioned with respect to the cutting line 13 (the cutting blade 4). Thereafter, the start switches 12a and 12b (see FIG. 4) of the sheet cutting machine are pressed by tile operator, the second cutting operation is started, and the cutting blade 4 moves downward from the standby position to the cutting position, and then returned to the standby position Accordingly, the left side 3c of the sheet bundle 3 is cut. In the same manner, the third and fourth cutting operations are performed, and on each occasion the sheet bundle 3 is rotated at 90 degrees in a counterclockwise direction by the operator. Therefore, the book block for manufacturing the finished book of A4 size is obtained when the fourth cutting operation is finished.

In this sheet cutting machine, the positioning block 6 is automatically located at a predetermined position by the control section 14 for each cutting operation. Accordingly, for example, if the sheet bundle 3 is arranged in a wrong orientation at the first cutting operation, and the lower side 3b of the sheet bundle 3 is abutted on the positioning block 6 as shown in FIG. 8, the sheet bundle 3 is not cut at a correct position, and a defective book block is manufactured. In addition, even if the sheet bundle 3 is cut correctly at the first cutting operation, if the sheet bundle 3 is arranged in a wrong orientation at the second cutting operation, a defective book block is also manufactured in this case.

Consequently, it is necessary for the operator to always pay attention to the orientation of the sheet bundle 6 with respect to the positioning block 6 during the cutting operation of the sheet bundle, which leads to workload. There arises also a problem that an unskilled operator tends to make an error in cutting operation.

### SUMMARY OF THE INVENTION

Accordingly, an object of the present invention is to prevent an error of cutting operation caused by an erroneous positioning of a sheet bundle with respect to a positioning block, in a sheet cutting machine which has the function of automatically setting of a position of a positioning block according to a order of cutting of each side of the sheet bundle.

In order to achieve the object, according to the present invention, there is provided a sheet cutting machine comprising: a frame; a table attached to the frame, a sheet bundle being placed on the table; a cutting blade arranged above the table and opposite to the table so as to cut four sides of the sheet bundle; a blade receiving plate arranged on the table and opposite to the cutting blade; a blade drive mechanism attached to the frame and supporting the cutting blade in such a manner that the cutting blade makes a reciprocal vertical movement between a standby position at which the cutting blade is spaced apart upward from the sheet bundle, and a cutting position at which the cutting blade comes into contact with the blade receiving plate to cut the sheet bundle; a positioning block arranged on the table parallel to the blade receiving plate for slide movement in directions toward and away from the blade receiving plate, a reference side of the sheet bundle being abutted on the positioning block, whereby the sheet bundle is positioned with respect to the cutting blade; a positioning block drive mechanism attached to the frame and moving the positioning block; an operation data storage section storing data of a order of cutting of each side of the sheet bundle, data of a distance between a cutting line of the positioning block and the sheet bundle for each cutting operation accordance with the order of cutting, and data of both a direction and an angle of rotation of the sheet bundle for each the cutting operation; a control section controlling the positioning block drive mechanism based on the data of the distance between the cutting line of the positioning block and the sheet bundle for each the cutting operation recorded in the operation data storage section in such a manner that the positioning block is located at a predetermined position for each the cutting operation; and an indication section indicating the order of cutting. The indication section comprises: a display; an image data storage section recording image data of the sheet bundle and image data of the positioning block; an image synthesis section reading the image data of the sheet bundle and the image data of the positioning block from the image data storage section, processing the two image data based on the data of both the direction and the angle of rotation of the sheet bundle of the cutting operation read out of the operation data storage section, and generating data of a composite image of the cutting operation each time the cutting operation is carried out; and an image display section reading from the operation data storage section the data of the distance between the cutting line of the positioning block and the sheet bundle of the cutting operation, and displaying the distance on the display together with the order of the cutting operation and the composite image each time the cutting operation is carried out.

According to a preferred embodiment of the present invention, the positioning block drive mechanism comprises: a slit formed on the table and extending perpendicularly to the blade receiving plate; an extension portion extending downward from a lower face of the positioning block through the slit, the positioning block being guided by the slit for the slide movement, the extension portion of the positioning block having a through hole with a thread groove extending in a direction of the slide movement; a feed screw attached to the frame underside the table and extending along the slit and arranged for rotation around the axis thereof, the feed screw being screwed into the through hole of the extension portion; and a motor attached to the frame and rotating the feed screw.

According to another preferred embodiment of the present invention, the sheet cutting machine further comprises a pair of auxiliary positioning blocks arranged on the table and extending normal to the positioning block on both ends of the positioning block, the reference side of the sheet bundle being abutted on the positioning block, the second reference side of the sheet bundle being abutted on one of the auxiliary positioning blocks, whereby the sheet bundle is positioned with respect to the cutting blade. Image data of the pair of auxiliary positioning blocks is stored in the image data storage section of the indication section, and the image synthesis section generates data of the composite image based on the image data of the sheet bundle, the image data of the positioning block and the image data of the pair of auxiliary positioning block.

### BRIEF DESCRIPTION OF THE DRAWINGS

FIG. 1 is a block diagram illustrating a structure of an indication section of a sheet cutting machine according to a first embodiment of the present invention;

FIG. 2 is a plan view illustrating a display screen of a sheet cutting machine according to the present invention;

FIGS. 3A to 3D are plan views illustrating a series of composite images indicated on a display screen of FIG. 2 for each cutting operation;

FIG. 4 is a perspective view of a conventional sheet cutting machine;

FIG. 5 is a perspective view schematically illustrating a structure of a positioning block drive mechanism of the sheet cutting machine shown in FIG. 4;

FIG. 6 is a plan view illustrating a display screen of an indication section of the sheet cutting machine shown in FIG. 4;

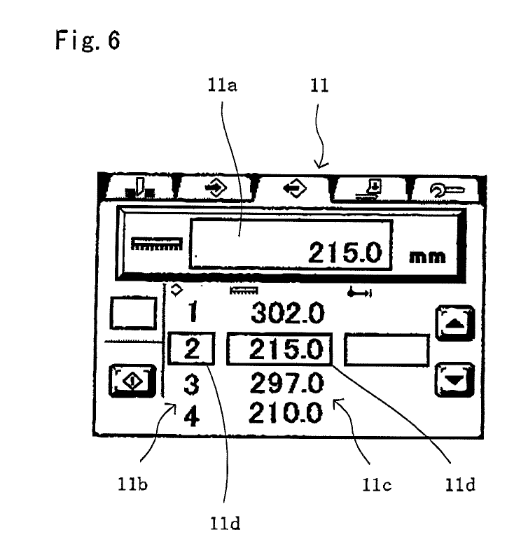

FIG. 7 is a plan view illustrating an example of an arrangement of a sheet bundle during a cutting operation by the sheet cutting machine shown in FIG. 4; and

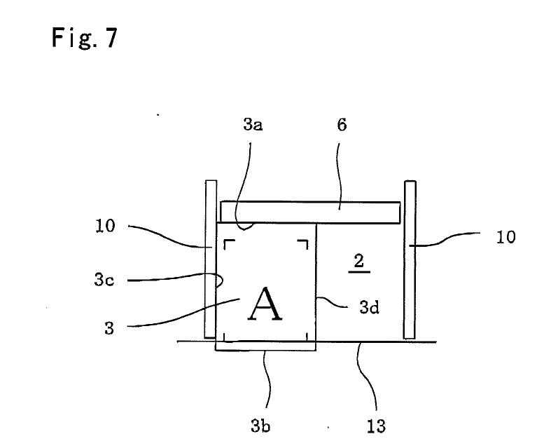

FIG. 8 is a plan view illustrating an example of the arrangement of the sheet bundle during the cutting operation by the sheet cutting machine shown in FIG. 4.

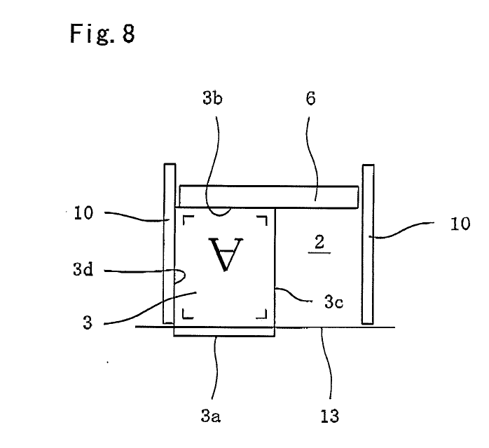

### DETAILED EXPLANATION OF THE PREFERRED EMBODIMENTS

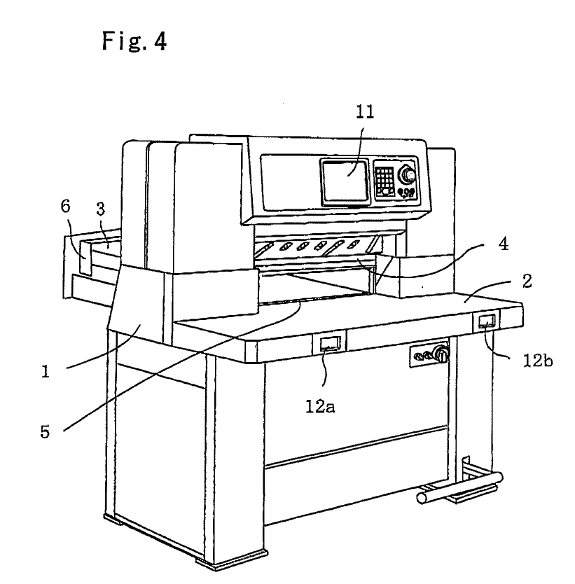

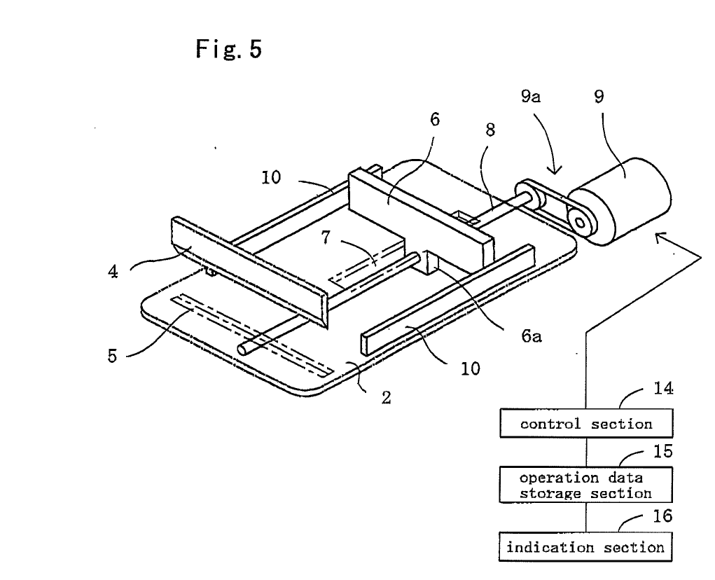

Hereinafter, a preferred embodiment according to the present invention will be described with reference to the accompanying drawings. A sheet cutting machine according to the present invention is different from a conventional sheet cutting machine in only a structure of an indication section and a structure of an operation data storage section corresponding thereto. Accordingly, an outer appearance of the sheet cutting machine according to the present invention is the same as the conventional sheet cutting machine shown in FIG. 4 except for a screen page of display of the indication section, and a structure of a table peripheral portion of the sheet cutting machine is also the same as the conventional example shown in FIG. 5. Therefore, a structural portion of the sheet cutting machine according to the present invention which is different from the conventional example will be described in detail below.

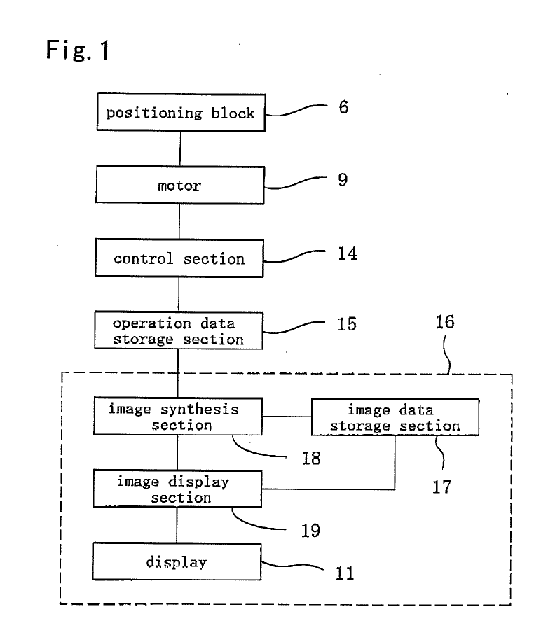

FIG. 1 is a block diagram illustrating a structure of the indication section of the sheet cutting machine according to an embodiment of the present invention. Referring to FIG. 1, according to the present invention, the sheet cutting machine comprises an operation data storage section 15 storing data of a order of cutting of each side of a sheet bundle 3, and data of a distance between a cutting line of a positioning block 6 and the sheet bundle 3 for each cutting operation accordance with the order of cutting, and data of both a direction and an angle of rotation of the sheet bundle 3 for each cutting operation. A control section 14 controls a motor 9 to arrange the positioning block 6 at a predetermined position for each cutting operation based on the data of the distance between the cutting line between the positioning block 6 and the sheet bundle 3 for each cutting operation.

In this embodiment, each of the data is inputted to the operation data storage section 15 as follows. First of all, the data of the distance between the cutting line of the positioning block 6 and the sheet bundle 3 for each cutting operation is inputted to the operation data storage section 15 by the control section 14 receiving data of printing (data relating to a print area of a sheet) from a printer arranged in a printing process prior to the sheet cutting process through a data communication and a data recording media, acquiring a necessary data by computing the received data of printing, and storing the acquired data in the operation data storage section 15.

For example, when the printing for the finished book of A4 size is carried out on sheets, in the data of printing, reference positions corresponding to a bottom edge and a spine of the finished book are set on the sheets. Based on the data of the reference positions, the control section 14 of the sheet cutting machine calculates a position of the positioning block 6 at the time of cutting a side corresponding to a top edge of the finished book, and then stores the calculated value as the data of the distance between the cutting line of the positioning block 6 and the sheet bundle 3 of a first cutting operation, in the operation data storage section 15. The control section 14 calculates the position of the positioning block 6 at the time of cutting a side corresponding to a front edge of the finished book, and stores the calculated value as the data of the distance between the cutting line of the positioning block 6 and the sheet bundle 3 of a second cutting operation, in the operation data storage section 15. The control section 14 calculates the position of the positioning block 6 at the time of cutting a side corresponding to the bottom edge of the finished book, and stores the calculated value as the data of the distance between the cutting line of the positioning block 6 and the sheet bundle 3 of a third cutting operation, in the operation data storage section 15. Finally, the control section 14 calculates the position of the positioning block 6 at the time of cutting a side corresponding to the spine of the finished book, and stores the calculated value as the data of the distance between the cutting line of the positioning block 6 and the sheet bundle 3 for a fourth cutting operation, in the operation data storage section 15.

Further, the data of both the direction and the angle of rotation of the sheet bundle 3 for each cutting operation is inputted by an operator from a data input section provided in the sheet cutting machine, and is stored in the operation data storage section 15.

In this embodiment, as mentioned above, a side corresponding to the top edge of the finished book is cut at the first cutting operation, a side corresponding to the front edge of the finished book is cut at the second cutting operation, a side corresponding to the bottom edge of the finished book is cut at the third cutting operation, and a side corresponding to the spine of the finished book is cut at the fourth cutting operation. Corresponding to this order of cutting, the angle of rotation of the sheet bundle 3 of the first cutting operation is set to 0 degrees, the direction of rotation of the sheet bundle 3 of the second cutting operation is set to a counterclockwise direction, and the angle of rotation thereof is set to 90 degrees. In addition, the direction of rotation of the sheet bundle 3 of the third cutting operation is set to a counterclockwise direction, and the angle of rotation thereof is set to 90 degrees, and the direction of rotation of the sheet bundle 3 of the fourth cutting operation is set to a counterclockwise direction, and the angle of rotation thereof is set to 90 degrees.

In this cases the data of the direction and the angle of rotation of the sheet bundle 3 for each cutting operation may be automatically inputted to the operation data storage section 15 by the control section 14 based on the data of printing.

The indication section 16 comprises a display 11, and an image data storage section 17 storing image data of the sheet bundle 3 and image data of the positioning block 6 together with image data of a pair of auxiliary positioning blocks 10. The image data of the sheet bundle 3, the positioning block 6 and the auxiliary positioning blocks 10 become original data of a composite image generated for each cutting operation, as mentioned below. In this embodiment, each of the image data of the sheet bundle 3, the positioning block 6 and the auxiliary positioning blocks 10 is its plane image data. The image data of the positioning block 6 and the auxiliary positioning block 10 is previously stored in the image data storage section 17, whereas the image data of the sheet bundle 3 is obtained by the control section 14 receiving the image data of the printed sheet bundle acquired by the printing process through data communication. In this case, the image of the auxiliary positioning blocks 10 is included in the composite image as necessary. When the image of the auxiliary positioning blocks 10 is not necessary, it is not stored in the image data storage section 17.

The indication section 16 also comprises an image synthesis section 18 reading the image data of the sheet bundle 3 and the image data of the positioning block 6 from the image data storage section 17, processing the two image data based on the data of both the direction and the angle of rotation of the sheet bundle 3 of the cutting operation read out of the operation data storage section 15, and generating data of a composite image of the cutting operation each time the cutting operation is carried out. The indication section 16 further comprises an image display section 19 reading from the operation data storage section 15 the data of the distance between the cutting line of the positioning block 6 and the sheet bundle 3 of the cutting operation, and displaying the distance on the display 11 together with the order of the cutting operation and the composite image each time the cutting operation is carried out.

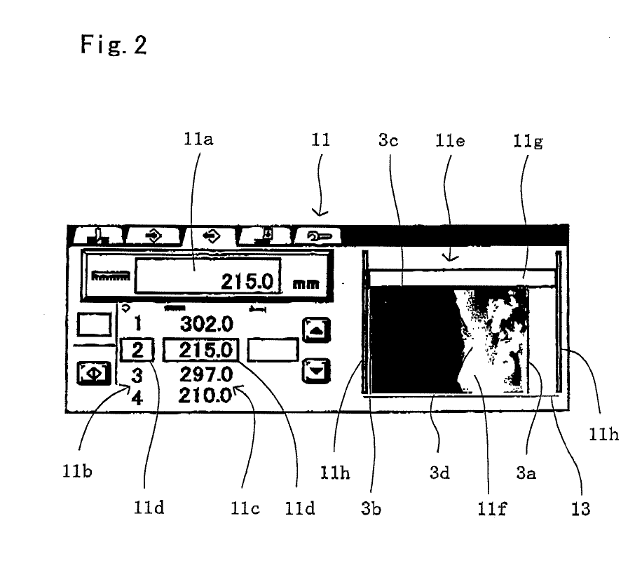

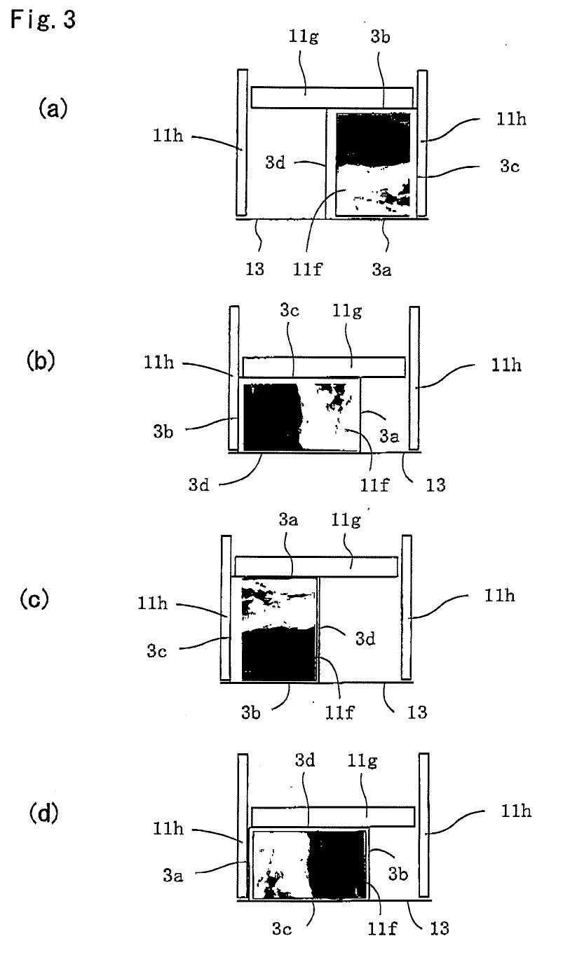

FIG. 2 is a plan view illustrating a screen page displayed on the display 11, and FIG. 3 is a plan view illustrating a series of composite images indicated on the screen page of FIG. 2 for each cutting operation.

FIG. 2 illustrates an example of cutting operation for manufacturing a finished book of A4 size. In FIG. 2, the reference numeral 11a represents a screen area indicating the distance between the cutting line of the positioning block 6 and the sheet bundle 3 of the next cutting operation, the reference numeral 11b represents a screen area indicating the order of cutting of four sides of the sheet, and the reference numeral 11c represents a screen area indicating the distance between the cutting line of the positioning block 6 and the sheet bundle 3 for each cutting operation accordance with the order of cutting. The reference numeral 11d represents a frame display indicating what number of cutting operation is performed next.

In other words, the screen page shown in FIG. 2 indicates that the distance between the cutting line of the positioning block 6 and the sheet bundle 3 is set to 302.0 mm at the first cutting operation, the distance between the cutting line of the positioning block 6 and the sheet bundle 3 is set to 215.0 mm at the second cutting operation, the distance between the cutting line of the positioning block 6 and the sheet bundle 3 is set to 297.0 mm at the third cutting operation, and the distance between the cutting line of the positioning block 6 and the sheet bundle 3 is set to 210.0 mm at the fourth cutting operation. The screen page also indicates that the second cutting operation is performed next, and the distance between the cutting line of the positioning block 6 and the sheet bundle 3 is set to 215.0 mm.

In FIG. 2, the reference numeral 11e represents a screen area indicating the composite image of the sheet bundle 3, the positioning block 6 and the auxiliary positioning blocks 10, the reference numeral 11f represents an image of the sheet bundle 3, the reference numeral 11g represents an image of the positioning block 6, and the reference numeral 11h represents an image of the auxiliary positioning blocks 10, respectively. In FIG. 2, the composite image of the screen area 11e indicates that, in the second cutting operation, the sheet bundle 3 should be positioned with respect to the cutting line 13 (the cutting blade 4) by abutting a side (a left side) 3c of the sheet bundle 3 on the positioning block 6 and abutting a side (a lower side) 3b of the sheet bundle 3 on one of the auxiliary positioning blocks 10.

When the cutting operation of the sheet cutting machine is started, the control section 14 first of all reads from the operation data storage section 15 the data (302.0 mm) of the distance between the cutting line of the positioning block 6 and the sheet bundle 3 of the first cutting operation, and arranges the positioning block 6 at a predetermined position. The image synthesis section 18 reads from the operation data storing portion 15 the data (the angle of rotation 0 degrees) of the direction and the angle of rotation of the sheet bundle 3 of the first cutting operation, and, based on the data, process the image data of both the sheet bundle 3 and the positioning block 6 read from the image data storage section 15 so as to generate the composite image (an image in which the lower side 3b of the sheet bundle 3 abuts on the positioning block 6, and the left side 3c of the sheet bundle 3 abuts on one of the auxiliary positioning blocks 10, respectively, see FIG. 3A). Thereafter, the image display section 19 displays the composite image on the screen area 11e of the display 11. Based on the image displayed on the screen area 11e, the operator can correctly position the sheet bundle 3 with respect to the cutting line 13 (the cutting blade 4) by abutting the lower side 3b of the sheet bundle 3 on the positioning block 6 and abutting the left side 3c on one of the auxiliary positioning blocks 10. Then the start switches 12a and 12b (see FIG. 4) of the sheet cutting machine are pressed by the operator, the first cutting operation is started, and the cutting blade 4 moves downward from the standby position to the cutting position, and then returned to the standby position, so that an upper side 3a of the sheet bundle 3 is cut.

When the first cutting operation is finished, the control section 14 reads from the operation data storage section 15 the data (215.0 mm) of the distance between the cutting line of the positioning block 6 and the sheet bundle 3 of the second cutting operation, and arranges the positioning block 6 at a predetermined position. The image synthesis section 18 reads from the operation data storage section 15 the data (90 degrees in a counterclockwise direction) of the direction and the angle of rotation of the sheet bundle 3 of the second cutting operation, and, based on the data, processes the image data of both the sheet bundle 3 and the positioning block 6 read from the image data storage section 15 so as to generate the composite image (the image in which the left side 3c of the sheet bundle 3 abuts on the positioning block 6, and the lower side 3b abuts on one of the auxiliary positioning blocks 10, see FIG. 3B). Thereafter, the image display section 19 displays the composite image in the screen area 11e of the display 11. Based on the image displayed in the screen area 11e, the operator can correctly position the sheet bundle 3 with respect to the cutting line 13 (the cutting blade 4) by abutting the left side 3c of the sheet bundle 3 on the positioning block 6 and abutting the lower side 3b on one of the auxiliary positioning blocks 10. Further, the start switches 12a and 12b (see FIG. 4) of the sheet cutting machine are pressed by the operator, the second cutting operation is started, and the cutting blade 4 moves downward from the standby position to the cutting position, and then returned to the standby position, so that a right side 3d of the sheet bundle 3 is cut.

In the same manner, the third and fourth cutting operations are performed, and on each occasion the sheet bundle 3 is rotated by the operator according to the image displayed in the screen area 11e of the display 11 and the sheet bundle 3 is correctly positioned with respect to the cutting line 13 (the cutting blade 4). When the fourth cutting operation is finished, the book block for manufacturing a finished book of A4 size can be obtained.

According to the present invention, since the orientation of the sheet bundle 3 with respect to the positioning block 6 is indicated on the display screen for each cutting operation, the operator can easily confirm the orientation of the sheet bundle 3 by looking at the display screen. Accordingly, it is possible to greatly reduce the error of cutting caused by erroneous positioning of the sheet bundle with respect to the positioning block.

1. A sheet cutting machine comprising:
a frame (1);
a table (2) attached to said frame (1), a sheet bundle (3) being placed on said table (2);
a cutting blade (4) arranged above said table (2) and opposite to said table (2) so as to cut four sides of said sheet bundle (3);
a blade receiving plate (5) arranged on said table (2) and opposite to said cutting blade (4);
a blade drive mechanism attached to said frame (1) and supporting said cutting blade (4) in such a manner that said cutting blade (4) makes a reciprocal vertical movement between a standby position at which said cutting blade (4) is spaced apart upward from said sheet bundle (3), and a cutting position at which said cutting blade (4) comes into contact with said blade receiving plate (5) to cut said sheet bundle (3);
a positioning block (6) arranged on said table (2) parallel to said blade receiving plate (5) for slide movement in directions toward and away from said blade receiving plate (5), a reference side of said sheet bundle (3) being abutted on said positioning block (6), whereby said sheet bundle (3) is positioned with respect to said cutting blade (4);
a positioning block drive mechanism attached to said frame (1) and moving said positioning block (6);
an operation data storage section (15) storing data of a order of cutting of each side of said sheet bundle (3), data of a distance between a cutting line of said positioning block (6) and said sheet bundle (3) for each cutting operation accordance with said order of cutting, and data of both a direction and an angle of rotation of said sheet bundle (3) for each said cutting operation;
a control section (14) controlling said positioning block drive mechanism based on the data of the distance between the cutting line of said positioning block (6) and said sheet bundle (3) for each said cutting operation recorded in said operation data storage section (15) in such a manner that said positioning block (6) is located at a predetermined position for each said cutting operation; and
an indication section (16) indicating said order of cutting,
said indication section (16) comprising:
a display (11);
an image data storage section (17) recording image data of said sheet bundle (3) and image data of said positioning block;
an image synthesis section (18) reading the image data of said sheet bundle (3) and the image data of said positioning block (6) from said image data storage section (17), processing the two image data based on the data of both the direction and the angle of rotation of said sheet bundle (3) of said cutting operation read out of said operation data storage section (15), and generating data of a composite image of said cutting operation each time said cutting operation is carried out; and
an image display section (19) reading from said operation data storage section (15) the data of the distance between the cutting line of said positioning block (6) and said sheet bundle (3) of said cutting operation, and displaying said distance on said display (11) together with the order of said cutting operation and said composite image each time said cutting operation is carried out.

2. The sheet cutting machine according to claim 1, wherein said positioning block drive mechanism comprises:
a slit (7) formed on said table (2) and extending perpendicularly to said blade receiving plate (5);
an extension portion (6a) extending downward from a lower face of said positioning block (6) through said slit (7), said positioning block (6) being guided by said slit (7) for said slide movement, said extension portion (6a) of said positioning block (6) having a through hole with a thread groove extending in a direction of said slide movement;
a feed screw (8) attached to said frame (1) underside said table (7) and extending along said slit (7) and arranged for rotation around the axis thereof, said feed screw (8) being screwed into said through hole of said extension portion (6a); and
a motor (9) attached to said frame (1) and rotating said feed screw (8).

3. The sheet cutting machine according to claim 2, further comprising a pair of auxiliary positioning blocks (10) arranged on said table (2) and extending normal to said positioning block (6) on both ends of said positioning block (6), said reference side of said sheet bundle (3) being abutted on said positioning block (6), the second reference side of said sheet bundle (3) being abutted on one of said auxiliary positioning blocks (10), whereby said sheet bundle (3) is positioned with respect to said cutting blade (4), and
wherein image data of said pair of auxiliary positioning blocks (10) is stored in said image data storage section (17) of said indication section (16), and said image synthesis section (18) generates data of said composite image based on the image data of said sheet bundle (3), the image data of said positioning block (6) and the image data of said pair of auxiliary positioning block.
